(19) United States
(12) Patent Application Publication
(10) Pub. No.: US 2024/0298126 A1
(43) Pub. Date: Sep. 5, 2024

(54) SPECIAL EFFECT PRODUCTION SYSTEM AND METHODS USEFUL IN CONJUNCTION THEREWITH

(71) Applicant: CDI HOLDINGS (1987) LTD., Karmiel (IL)

(72) Inventors: Menachem CIGFINGER, Har Adar (IL); Doron YECHEZKEL, Ra'anana (IL); Alon SARID, Tel Aviv (IL); Tal LEIZER, Zikhron Ya'akov (IL); Nir ASHKENAZY, Caesarea (IL); Moshe SHOMER, Tel Aviv (IL); Dan TALMI, Yaad (IL)

(21) Appl. No.: 17/905,796

(22) PCT Filed: Mar. 2, 2021
(86) PCT No.: PCT/IL2021/050231

§ 371 Date: Sep. 7, 2022

(30) Foreign Application Priority Data
Mar. 31, 2020 (IL) 273714

(51) Int. Cl. H04R 27/00

(52) U.S. Cl. CPC H04R 27/00; H04R 2201/023

(57) ABSTRACT

Plural portable devices, configured to produce special effect/s, responsive to a controller configured to provide instructions, on occasions separated by a time interval of t seconds, to transmitter/s, to transmit commands to the portable devices to produce a special effect at a time separated by S seconds from a first occasion, on which the devices receive from the controller commands to begin producing the special effect in S seconds. On a second occasion the devices receive from the controller commands to begin producing the special effect in (S-1) seconds, such that the plural devices produce the special effect synchronously and even devices which received only some of the commands transmitted, participate in production of special effects.

### FIELD OF THIS DISCLOSURE

The present invention relates generally to sound production, and more particularly to portable devices which produce (inter alia) sound.

### BACKGROUND FOR THIS DISCLOSURE

The patent literature describes synchronized playout of music on personal digital music players in U.S. Pat. No. 8,515,338B2, and describes a lighting device e.g. presented as a bracelet, in U.S. Pat. No. 9,686,843B2, and describes a customized audio display system in US20160165690.

Wearable LED (light emitting diode) devices are known. For example, Wikipedia describes that “PixMob is a wireless lighting company which specializes in creating immersive experiences and performances that break the barrier between the crowd and the stage. PixMob's wearable LED devices are controlled with infrared light, generating colorful effects synchronized with sound and visuals. People become a part of the show—each PixMob device turns every person into a pixel, transforming the crowd into a huge canvas.”

Disc jockeying software solutions, as well as standalone hardware samplers (such as Elektron Octatrack MK II, Akai Mpc Live, Akai Mpc X, Pioneer DJ DJS −1000, Elektron Digitakt) are known. These are operated centrally.

MIDI (Musical Instrument Digital Interface) is a standard for communications protocol, digital interface, and electrical connectors useful for compatible electronic musical instruments, computers, and other devices. MIDI allows MIDI-compatible electronic or digital musical instruments to communicate with each other and control each other. MIDI events can be sequenced with computer software, or in hardware workstations. MIDI includes commands that create sound, thus it is possible to change key, instrumentation or tempo of a MIDI arrangement, or reorder individual sections. Standard, portable commands and parameters e.g. in MIDI 1.0 and General MIDI (GM) may be used to share musical data files among various electronic instruments. Data composed via sequenced MIDI recordings can be saved as a standard MIDI file (SMF), digitally distributed, and reproduced by any device that adheres to the same MIDI, GM, and SMF standards. The personal computer in a MIDI system can serve multiple purposes, depending on the software loaded to the PC. Multitasking allows simultaneous operation of plural programs that may share data. MIDI can control any electronic or digital device that can read and process a MIDI command. The receiving device or object may include a general MIDI processor, and program changes trigger a function on that device similar to triggering notes from a MIDI instrument's controller. Each function can be set to a timer controlled by MIDI, or another trigger.

DMX is an example of a protocol which may be used for lighting control including by live DJs, desiring their control surfaces to speak to other elements.

It is appreciated that alternatively or in addition, any other suitable sound and/or light synchronization protocols may be employed, such as but not limited to:
LTC-Linear Time Code
MTC-Midi Time Code
WC-Word Clock
MC-Midi Clock (option).

A method for adding delayed speakers to a PA system is described in the following https www link: https://www.sweetwater.com/insync/timing-is-everything-time-aligning-supplemental-speakers-for-your-pa/.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments provide a central unit and distributed samplers, typically a multiplicity of additional samplers e.g. one per audience member or participant, per event or performance. Embodiments may use a system that translates languages currently used e.g. MIDI and OSC into an RF (say) frequency distribution command issued to the samples by the central unit. A human operator, e.g. a DJ, may be responsible for the main audio (and/or visual) effect through the central amplification system (PA), thereby to produce playback of data not from (e.g. which may be in addition to) the central amplification system. The system may disseminate more information from the DJ system through the RF frequency broadcast which activates the samplers (e.g. personal devices on each audience viewer) thereby to provide another audio channel that may be integrated with the central amplification system.

When broadcasting, the message may be received by all devices with various addresses which are listening to the appropriate frequency channel. Typically, when a device receives a packet, the device checks the packet's destination address to determine whether the device is an intended recipient for the packet. A short addressing mode may be used and a set destination address may be accepted by all the devices that receive the packet as their own address. Broadcast addresses may be used. More generally, any known broadcasting technology may be used.

Certain embodiments of the present invention seek to provide portable or wearable devices which produce sound and/or light.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A group of portable devices comprising all or any subset of the following:
plural portable devices, each typically configured to produce at least one special effect, responsive to a controller typically configured to provide instructions, on each of at least first and second occasions which are separated by a time interval whose length is t seconds, to at least one transmitter, to transmit commands to the plural portable devices to produce a special effect at a time separated by S seconds from the first occasion,
wherein on the first occasion the devices typically receive from the controller commands to begin producing the special effect in S seconds,
and on the second occasion the devices typically receive from the controller commands to begin producing the special effect in (S-t) seconds,
such that the plural devices typically produce the special effect synchronously and/or such that even portable special effect production devices, which received only some of the commands transmitted on the at least first and second occasions, participate in production of special effects.

Embodiment 2. A special effect production controlling system comprising all or any subset of:
a controller typically configured to provide instructions, on each of at least first and second occasions which are separated by a time interval whose length is t seconds, to a transmitter, to transmit commands to plural portable special effect production devices to produce a special effect at a time separated by S seconds from the first occasion,
wherein, on the first occasion, the controller typically commands the plural portable special effect production devices to begin producing the special effect in S seconds,
and on the second occasion, the controller typically commands the plural portable special effect production devices to begin producing the special effect in (S-t) seconds,
thereby to control the plural devices, responsive to the controller, to produce the special effect synchronously, and/or to enable production of special effects even by portable special effect production devices which received only some of the commands transmitted on the at least first and second occasions.

Embodiment 3. The system according to any of the preceding embodiments wherein the special effect comprises at least one audio effect.

Embodiment 4. The system according to any of the preceding embodiments wherein the controller is activated to command the transmitter to transmit commands during an event, and wherein the portable devices each include memory and are each pre-loaded, before the event, with at least one sound file stored at at least one respective location in the memory, and wherein the audio effect comprises playing the at least one sound file responsive to the commands to the portable devices, thereby to reduce data streaming during the event.

Embodiment 5. The system according to any of the preceding embodiments wherein the special effect comprises at least one lighting effect.

Embodiment 6. The system according to any of the preceding embodiments wherein the portable devices each include at least one light-emitting diode and wherein the lighting effect comprises activating the at least one light-emitting diode.

Embodiment 7. The system according to any of the preceding embodiments wherein the plural devices include, at least:
a first subset of devices preloaded with a first sound file at a memory location L and
a second subset of devices preloaded with a second file at the memory location L
and wherein the controller commands the devices to “play sound file at memory location L”, thereby to generate a special effect which includes, at least, the first subset of devices playing the first sound file and the second subset of devices playing the second file.

Embodiment 8. The system according to any of the preceding embodiments wherein the second file comprises an empty file, thereby to generate a special effect in which only the first subset of devices play the first sound file, whereas the second subset of devices is silent.

Embodiment 9. The system according to any of the preceding embodiments wherein the plural devices include at least a subset of devices all preloaded with a sound file at a memory location L and wherein the sound files preloaded at the memory location L in all devices belonging to the subset, are all identical.

Embodiment 10. The system according to any of the preceding embodiments wherein the plural devices include at least first and second groups of devices having first and second outward appearances respectively such that the first and second groups of devices differ in their outward appearances, and wherein all of the plural devices are preloaded with a sound file at a memory location L and wherein the sound files preloaded at the memory location L in all devices belonging to the first group, are all identical and the sound files preloaded at the memory location L in all devices belonging to the second group, all differ from the sound files preloaded at the memory location L in all devices belonging to the first group.

Embodiment 11. The system according to any of the preceding embodiments and wherein the first and second groups of devices include first and second housings respectively, and wherein the first and second housings differ in color thereby to facilitate distribution of the first group of devices in a first portion of a venue such as a lower hall and distribution of the second group of devices in a second portion of a venue such as an upper hall.

Embodiment 12. The system according to any of the preceding embodiments wherein each of the portable devices is operative to estimate its own distance from the transmitter and/or to calculate delay, and wherein at least one of the commands comprises a command to the devices to “take a first course of action if your distance from the transmitter exceeds a threshold and a second course of action otherwise”, thereby to allow subsets of the portable devices which differ from one another in terms of their respective distances from the transmitter, to be simultaneously commanded to take different courses of action and/or to yield playback, simultaneously and without delay, for devices which are closer to the transmitter's location and for devices which are a further distance from the transmitter's location.

Embodiment 13. The system according to any of the preceding embodiments wherein the portable devices estimate their own distances from the transmitter as a function of RSSI (Received Signal Strength Indicator) values characterizing commands the portable devices receive from the transmitter.

Embodiment 14. The system according to any of the preceding embodiments wherein at least one of the courses of action comprises playing at least one given preloaded sound file.

Embodiment 15. The system according to any of the preceding embodiments wherein at least one of the courses of action comprises taking no action.

Embodiment 16. The system according to any of the preceding embodiments wherein the at least one transmitter comprises at least 2 transmitters TXA and TXB deployed at locations a, b respectively, and wherein at least one individual portable device from among the portable devices is operative to estimate its own distances da and db from transmitters TXA and TXB respectively, to compare da and db and, accordingly, to determine whether the individual portable device is closer to location a or to location b.

Embodiment 17. The system according to any of the preceding embodiments wherein the special effect comprises at least one audio effect and at least one lighting effect.

Embodiment 18. The system according to any of the preceding embodiments wherein the commands to produce a special effect include an indication of an intensity at which the special effect is to be produced.

Embodiment 19. The system according to any of the preceding embodiments and also comprising the transmitter which comprises an RF transmitter.

Embodiment 20. The system according to any of the preceding embodiments wherein each portable device is configured to execute only a most recently received command, from among several commands received on several respective occasions.

Embodiment 21. The system according to any of the preceding embodiments wherein devices loaded with first sound files are provided to audience members entering via a first gate and devices loaded with second sound files are provided to audience members entering via a second gate.

Embodiment 22. The system according to any of the preceding embodiments wherein the controller is operative to receive, from a human operator, a time TO at which the special effect is desired and to command the transmitter to transmit the commands such that the time separated by S seconds from the first occasion is TO.

Embodiment 23. A special effect production controlling method comprising:
providing a controller configured to provide instructions, on each of at least first and second occasions which are separated by a time interval whose length is t seconds, to a transmitter, to transmit commands to plural portable special effect production devices, to produce a special effect at a time separated by S seconds from the first occasion,
wherein, on the first occasion, the controller commands the plural portable special effect production devices to begin producing the special effect in S seconds,
and, on the second occasion, the controller commands the plural portable special effect production devices to begin producing the special effect in (S-t) seconds,
thereby to control the plural devices, responsive to the controller, to produce the special effect synchronously and to enable production of special effects even by portable special effect production devices which received only some of the commands transmitted on the at least first and second occasions.

Embodiment 24. A method according to any of the preceding embodiments wherein at least one playback signal activation time is encoded so as to yield playback simultaneously for devices closer to the transmitter's location and for devices a further distance from the transmitter's location.

Embodiment 25. A computer program product, comprising a non-transitory tangible computer readable medium having computer readable program code embodied therein, the computer readable program code adapted to be executed to implement a special effect production controlling method comprising:
providing a controller configured to provide instructions, on each of at least first and second occasions which are separated by a time interval whose length is t seconds, to a transmitter, to transmit commands to plural portable special effect production devices, to produce a special effect at a time separated by S seconds from the first occasion,
wherein, on the first occasion, the controller commands the plural portable special effect production devices to begin producing the special effect in S seconds,
and, on the second occasion, the controller commands the plural portable special effect production devices to begin producing the special effect in (S-t) seconds,
thereby to control the plural devices, responsive to the controller, to produce the special effect synchronously and to enable production of special effects even by portable special effect production devices which received only some of the commands transmitted on the at least first and second occasions.

Embodiment 26. A special effect production controlling method comprising:

Providing plural portable devices, each configured to produce at least one special effect, responsive to a controller configured to provide instructions, on each of at least first and second occasions which are separated by a time interval whose length is t seconds, to at least one transmitter, to transmit commands to the plural portable devices to produce a special effect at a time separated by S seconds from the first occasion,
wherein on the first occasion the devices receive from the controller commands to begin producing the special effect in S seconds,
and on the second occasion the devices receive from the controller commands to begin producing the special effect in (S-t) seconds,
such that the plural devices produce the special effect synchronously and such that even portable special effect production devices, which received only some of the commands transmitted on the at least first and second occasions, participate in production of special effects.

Embodiment 27. A computer program product, comprising a non-transitory tangible computer readable medium having computer readable program code embodied therein, the computer readable program code adapted to be executed to implement a special effect production controlling method comprising:

Providing plural portable devices, each configured to produce at least one special effect, responsive to a controller configured to provide instructions, on each of at least first and second occasions which are separated by a time interval whose length is t seconds, to at least one transmitter, to transmit commands to the plural portable devices to produce a special effect at a time separated by S seconds from the first occasion,
wherein on the first occasion the devices receive from the controller commands to begin producing the special effect in S seconds,
and on the second occasion the devices receive from the controller commands to begin producing the special effect in (S-t) seconds,
such that the plural devices produce the special effect synchronously and such that even portable special effect production devices, which received only some of the commands transmitted on the at least first and second occasions, participate in production of special effects.

Embodiment 28. The system according any of the preceding embodiments wherein the portable devices estimate their own distance from the transmitter, and create time-aligned corrections to played sounds thereby to ensure sounds played by portable devices located close to the stage are heard at the same time as sounds played by devices located far from the stage and/or to solve sonic problems caused when electrical signals from transmitter reaches devices at various distances from a stage, simultaneously.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural, typically interconnected modules, running on plural respective servers, and so forth.

The above devices may communicate via any conventional wired or wireless digital communication means, e.g. via a wired or cellular telephone network or a computer network such as the Internet.

It is appreciated that apps referred to herein may include a cell app, mobile app, computer app or any other application software. Any application may be bundled with a computer and its system software, or published separately. The term “phone” and similar used herein is not intended to be limiting, and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus the computing device may even be disconnected from e.g., Wi-Fi, Bluetooth etc. but may be tethered directly or ultimately to a networked device.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s (references to which herein may be replaced by references to controller/s and vice versa) configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein, includes also the underlying logic which controls the data presented to the user e.g. by the system display, and receives and processes and/or provides to other modules herein, data entered by a user e.g. using her or his workstation/device.

### BRIEF DESCRIPTION OF THE DRAWINGS

Example embodiments are illustrated in the various drawings.

In particular, FIGS. 1a, 1b are simplified pictorial illustrations of components of the system which may be provided in accordance with embodiments.

FIG. 2a is a simplified block diagram of the controller aka control unit, according to an embodiment; all or any subset of the illustrated blocks may be provided.

FIG. 2b is a simplified block diagram of an individual portable or wearable special effect production device aka personal device aka soundpack aka sampler, according to an embodiment. All or any subset of the illustrated blocks may be provided.

FIGS. 3a-3k are tables/diagrams useful in understanding certain embodiments.

FIG. 4 is a table useful in understanding certain embodiments.

In the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

FIGS. 1a and 1b are simplified block diagrams of all or any subset of which are included in the system, suitably interrelated e.g. as shown.

Computational, functional or logical components described and illustrated herein can be implemented in various forms, for example, as hardware circuits, such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

An embodiment of the invention provides a special effect production system comprising all or any subset of the following: plural wearable special effect production devices (any reference herein to a portable device can also refer to wearable devices aka wearables, and vice versa), at least one transmitter, and a controller configured to provide instructions, on each of at least first and second occasions which are separated by a time interval whose length is t seconds, to the transmitter, to transmit commands to the plural wearable special effect production devices, to produce a special effect at a time separated by S seconds from the first occasion. Typically, on the first occasion, the controller commands the plural wearable special effect production devices to begin producing the special effect in S seconds. Typically, on the second occasion, the controller commands the plural wearable special effect production devices to begin producing the special effect in (S-t) seconds. This yields plural devices which produce the special effect synchronously and also enables production of special effects even by portable special effect production devices which received only some of the commands transmitted on the at least first and second occasions.

S and t are not necessarily integers, thus the time interval which is S seconds long may, in practice, be far shorter than one second. For example, S and t may be a few milliseconds or less, or may be a few hundredths of a second or more.

Each command is typically only a few bits long and may include a timestamp and/or an indication e.g. address in wearable memory of a sound file (e.g. song) to be played e.g. as described below in detail. It is appreciated that the population of wearables may be subdivided into subgroups (e.g. who may be seated in different areas, or by gender, or any other subgroups) and these subgroups may have different sound files pre-loaded at their various memory addresses. Thus for example, address A may store the team anthem of the yellow team, for all wearables distributed at the gate of the yellow team's section of the stadium, and may store the team anthem of the red team, for all wearables distributed at the gate of the red team's section of the stadium. Or, address A may store the team anthem of the yellow team, for all wearables distributed at the gate of the yellow team's section of the stadium, and may store an empty file, for all wearables distributed at the gate of the red team's section of the stadium, and also, address B may store the team anthem of the red team, for all wearables distributed at the gate of the red team's section of the stadium, and may store an empty file, for all wearables distributed at the gate of the yellow team's section of the stadium, e.g. to allow each team's anthem to be played exclusively, when that team scores (by giving a command to “play the sound file at address A” when yellow scores, and giving a command to “play the sound file at address B” when red scores. Or, address A may store a certain song in a certain key for all male audience members, and may store the same song an octave higher, in the wearables intended for distribution to female audience members. Or, address A may store “yay” for all wearables intended for distribution to child audience members, and may store “boo”, in the wearables intended for distribution to the adults accompanying the child audience members. Additionally, address B may store “yay” for all wearables intended for distribution to adult audience members, and may store “boo”, in the wearables intended for distribution to the child audience members. This allows a performer for children to stage live “arguments” between the children and adults in the audience, about some proposal of the performer, by creating a special effect in which, even if the actual shouted yay/boo response of the audience to a staged performer suggestion is partial or poor, the children hear loud shouts of, say, “yay” (from all kids) and “boo” (from all adults), or vice versa, all around them. Endless variations are possible, to achieve a rich variety of special effects.

The controller may be programmed, say by a disc jockey aka DJ, or other human operator e.g. via a conventional DJ console. For example, the controller may send a “turn on blue light” command at a timing coinciding with the first line of a song, and then a “turn on the green light” command a timing coinciding with the second line of a song, allowing a special effect to be achieved e.g. if the performer instructs the audience to wave their devices in the air as the lines of the song are played. Or the controller may have an API to a processor which automatically derives cues, e.g. an image processor which identifies that a team has scored from a video of the game, and automatically sends a command to the controller, to send out a command to play that team's anthem.

It is appreciated that the wearables may be configured in any suitable way and may have any suitable type of housing. The wearable may be a pendant or necklace or chain or bag with shoulder strap or magnet, or be clipped onto the end-user's clothing, or may have a loop to slip onto the user's wrist. Or, the wearable may have a strap to strap securely around the user's wrist. The wearable may or may not have a handle. All these variations are but examples.

If desired, first and second groups of devices may be provided which differ in their outward appearances, and all devices are preloaded with a sound file at a memory location L, but the sound files preloaded at the memory location L in all devices belonging to the first group, are all identical and the sound files preloaded at the memory location L, in all devices belonging to the second group, all differ from the sound files preloaded at the memory location L in all devices belonging to the first group. When this embodiment is employed, the first group may, say, be a different shape than the second group of wearables, or, alternatively, the first group of wearables may be configured, say, as a pendant, and the second group may be configured differently—e.g. as a bracelet. Either way, the different outward appearances allow venue attendants to easily distribute the 2 or n groups of devices, to various groups of event attendees (different seating, different gender, different age) respectively.

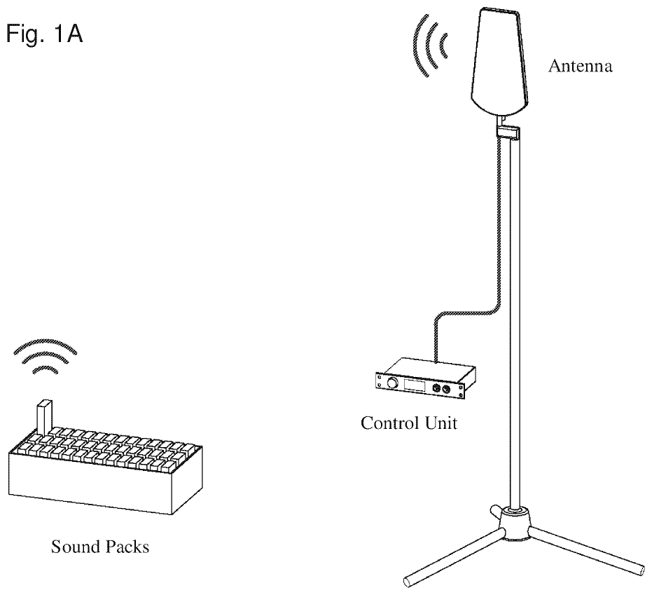

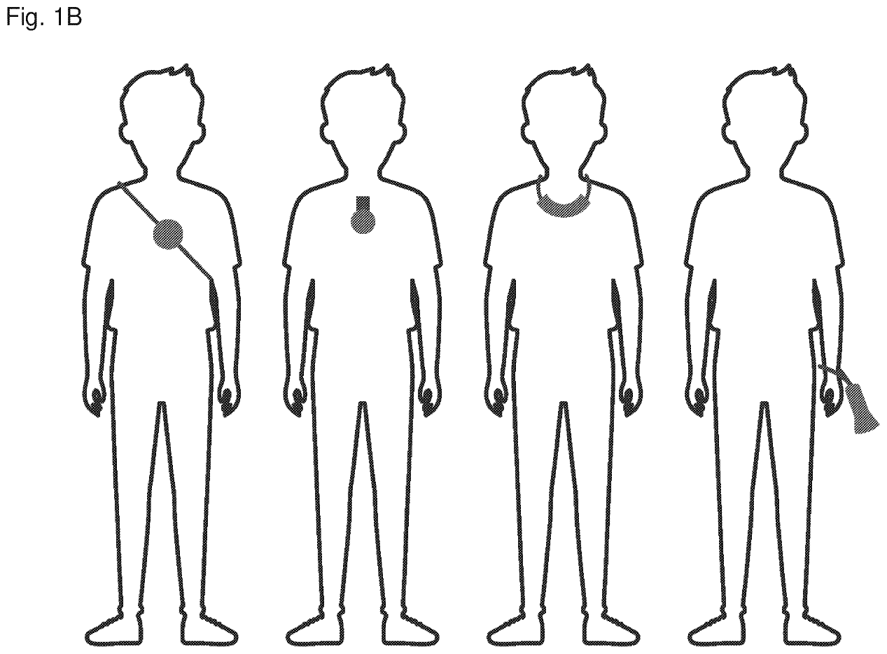

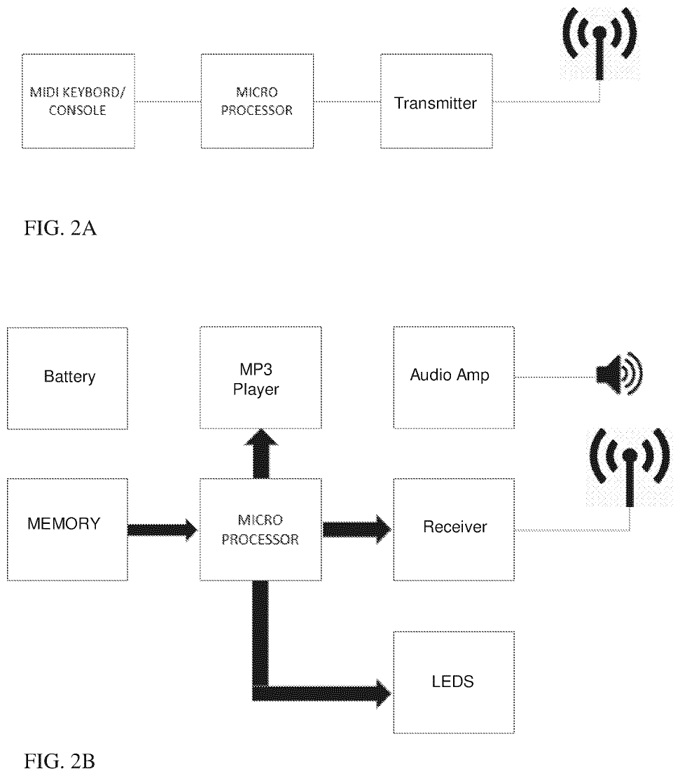

FIG. 2a is a simplified block diagram of the controller aka control unit, according to an embodiment. All or any subset of the illustrated blocks may be provided.

FIG. 2b is a simplified block diagram of an individual wearable special effect production device, aka personal device, aka soundpack, according to an embodiment. All or any subset of the illustrated blocks may be provided.

The control unit of FIG. 2a is typically located at the DJ/soundman area and may be connected to a suitable workstation such as the DJ's console e.g. using a USB or a midi cable. The control unit may generate a command according to a preprogrammed plan based on a timestamp e.g. as described herein and/or may be triggered by a leader e.g. in a musical performance, by one of the players on the stage (usually the keyboardist). The control unit may have any suitable operation flow e.g. may prepare a command for transmission e.g. as per a schedule provided by a central operator. Then, the command may be transmitted plural times (say 7 or 10 times), each time commanding that the same special effect be activated, each time within a different time interval from receipt. If the first command has not yet been sent out, the unit waits until it has, and ditto for the 2^{nd}, 3^{rd} etc. commands. Eventually, even the last command has been sent out, in which case, the unit has finished broadcasting that command and waits for the next command that the schedule requires. Once no more commands remain to be broadcast, operation of the control unit ends.

The trigger may contain data to be sent to the air from the control unit and may generate a specific sound/light or other special effect, according to the command transmitted.

The personal device of FIG. 2b may get a command (sent by the control unit) and may operate a special effect e.g. one or more (e.g. a sequence of) soundtrack/s (typically pre-loaded before the event into the personal device memory) or, say, to blink the personal device's color LED.

The opcode may be located on a memory block that may hold all sound files e.g. songs and visual effects e.g. light patterns, preprogrammed according to each specific show.

The personal device may have any suitable operation flow e.g. may wait for a command to be received. Once this occurs, the wearable may activate an internal timer in order to know when to execute the command (thereby to active the special effect). Once the time comes, the command (the most recently arrived command) is executed. Then, typically, the wearable cleans its memory from all data pertaining to the just executed command, and typically awaits the next command.

Any suitable transmission technology may be employed. For example, the instruments, e.g. soundpacks, may be operated remotely during the performance through the computer producer or keyboardist's computer systems. A dedicated PC computer/embedded system may be connected to a dedicated PC/embedded system that may take commands in the language in which the show was designed (e.g. MIDI or OSC) and convert it to commands that may be sent to devices in the audience via (say) radio or RF frequencies.

The RF frequencies may be sent to the soundpack aka device and may be a trigger for activating the device e.g. to generate lighting or sound. The command can be executed or generated either in advance, or by sending a “spontaneous” command by the music producer or keyboardist.

Frequencies may be recorded within the devices as a specific “code” run from the “code table”, which may contain encoding of the pre-recorded sound and lighting files on the device. The “code table” can vary, depending on the different locations within the show (for example, an X code that may be recorded on devices, may play on the devices on the right, and on the left may trigger a sound to be heard only from the right side of the auditorium).

The command may be sent from the (e.g. radio frequency aka RF) transmitter plural times to prevent cases where the devices did not receive the transmitted frequency (e.g. in the case of sample concealment) and are hence unable to participate. If the command is sent plural times, the more times this occurs, the less likely it is that a given device may be unable to participate. Alternatively or in addition, the command may be sent with session time coding, to create a synchronized session simultaneously for all segments of the audience, both for those who are close, and for those who are farther away from the stage, so that the entire audience will hear a uniform and synchronized sound from all parts of the hall.

This broadcast technology is advantageous in providing:

Sound synchronization-send and receive signals for sound playback in a harmonious and synchronized way by encoding the signal activation time. Thus, no signals are received with delay, and so there will be no delay in turning on the speakers, such that all are activated simultaneously, with perfect timing, thereby preventing cacophony and playing music simultaneously for both those who are close (e.g. to the stage of position of the transmitter) and those members of the audience who are further from the stage.

The signals may be transmitted multiple times (e.g. 10 times per each period of time, that is determined in advance), and each message or signal may be encoded, e.g. as described herein; the device will receive and know, according to the encoding, at which time the message is to be activated.

Transmission may be characterized by all or any subset of the following:
The device may always only refer to the last message it received (which obviates any need for a real-time clock and transmitter components in the devices, and allows devices which may include a timer (typically implemented in software) only, instead).
Sound and lighting may be turned on by the same method, without the need for Wi-Fi or Bluetooth.
Interfacing with existing means of managing and operating, without interruption to the sound and signals, which may be transmitted on a regular basis
Receiving the command sent from the DJ console at any point within the venue (which may be either open, e.g. an amphitheater or outdoor parade) or closed (e.g. an auditorium).
The ability to produce a complex array according to the audience's locations, or using different sound files according to different wings or regions or areas within the venue.
Personalization and customization capability for every producer and show.

It is appreciated that pre-feeding the files and sequentially transmitting the signals solves all or any subset of the following problems:
1. Solve the location problem—the location may be known in advance, and may be pre-entered information when a ticket is purchased
2. Solve the content issue—playback content is pre-populated
3. Solve the problem of masking—the frequencies are sent several times to activate the sound if the device is hidden or it did not receive the frequency the first time
4. Resolve the synchronization problem—sending timely coded session messages

Such broadcast technology is performed by sending signals to devices with a n activation message in X time. By means of such innovation, the problem of masking and synchronization of devices is solved, by sending a sequence of signals that are different from one another, as follows:
Each time a signal is set to a different time stamp to start the sound/lighting session
The signal is sent with Delta to activate the sound/lighting.
The signal is sent at intervals consecutively, without knowing whether it has been received or not.

In some embodiments, a table is loaded that matches locations at the point of sale. Another way to determine the relevant location and files, is by transmitting to the device through NFC (or known alternative short-range technology) at the viewer's entrance to the show, through the relevant gate. All devices are loaded with the same content when some of the sound files are activated and others are not. This method typically associates the relevant files to the location where the viewer is within view, without the need to load different files on the devices in advance.

Production of special effects according to an embodiment, using e.g. the apparatus of FIGS. 2a-2b, is now described.

The command broadcast may be controlled from the DJ workstation.

The transmission may be performed by a 433 Mhz (say, depending on the frequency a given country may allow) frequency transmitter in a suitable standard e.g. the LORA standard, and 868 Mhz (say) frequencies (frequencies may depend on the approved standards in different countries).

It is appreciated that all references to LORA herein are merely by way of example, since any other suitable communication protocol may be employed, such as but not limited to LoraWAN, FSK, GSM, QPSK, Rolling code.

During a performance various functions or special effects may have been pre-loaded on the receiving wearable devices. Scheduling of the commands may be entered into the broadcast system or transmitter before each performance (in coordination with the video art personnel, to obtain appropriate scheduling, to execute functions according to the performance).

Typically the algorithm is configured to:
1. Ensure a high percentage of messages received by the receiver units; and/or 2. Prevent drifting as much as possible, so that the messages leave at a fixed and accurate
time.

Ensuring a high percentage of messages are received may be achieved by transmitting the same command several times, but each command has a sector in the message which may set the time to wait (depending on the time the command is sent) until the command is executed, such that all commands result in command execution at the same time.

By using a different timestamp for each broadcast that may set the remaining time until execution, an internal timer may be transmitted to the recording unit. The command may be executed at the right time, even if only one message out of the ten that were broadcast, is received.

Any command that is received may recur.

It is appreciated that embodiments herein allow issues of drift that may occur in conventional systems, to be overcome.

Example operation: packet size can vary and the packets below are mere examples of possible packet architectures, populated with example values. An initial broadcast is shown in FIG. wherein the notation is:
S-Packet start
X-Timestamp setting time
D-Command
C-Error correction
S-Start receiving broadcast (can be “0” no message received or “1” has been received message)

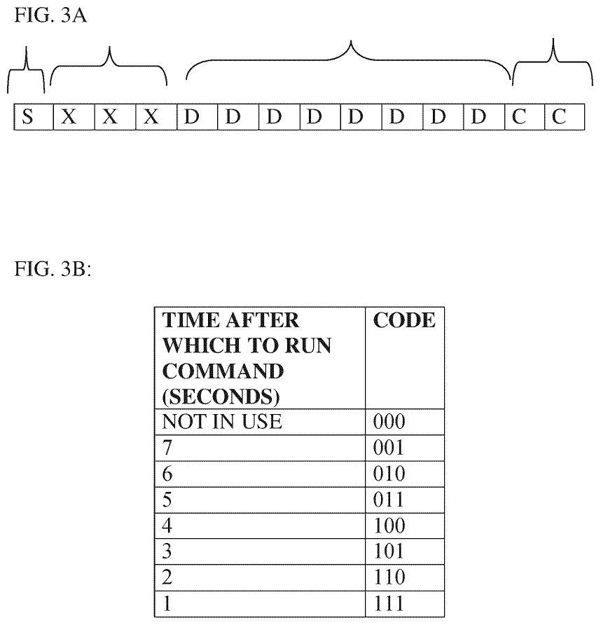

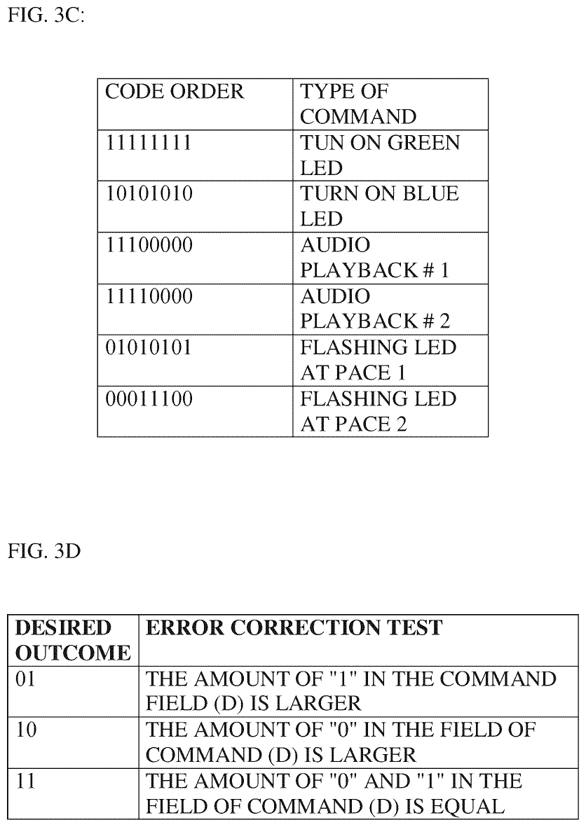

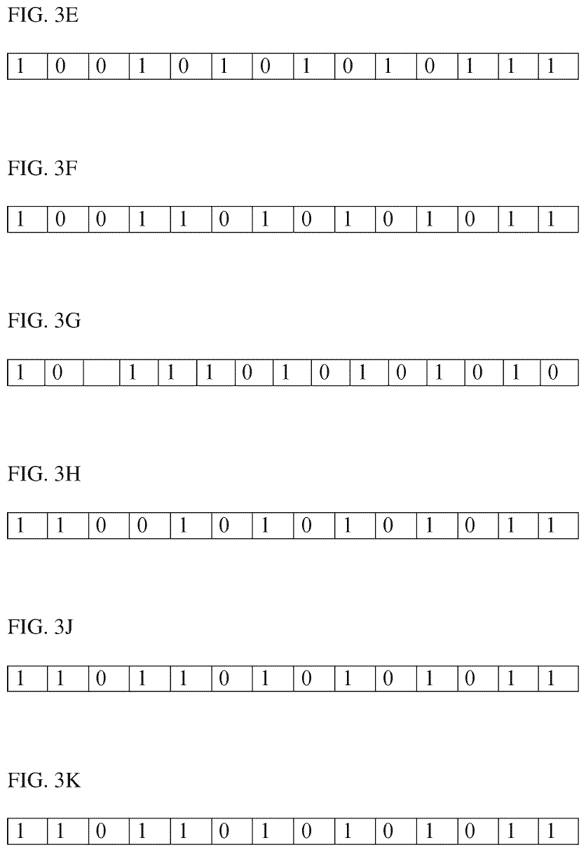

XXX-Set 3 bytes of standby time until the action is performed, in accordance with the table of FIG. 3b. In the example of FIG. 3b, commands are executed between 1 and 7 seconds after having been received (typically, unless the error correction code fails). However, this is not intended to be limiting.

D-Command to Execute—The command to execute may be executed by the processor and the software that may convert the message to execute a command. For example, the various bit sequences may refer to the commands respectively listed in the table of FIG. 3c. It is appreciated that “audio playbacks” 1 and 2, are typically pre-loaded into the wearables so as to prevent heavy transmissions during actual run-time (during a performance or parade e.g.).

C typically denotes conventional error correction code, which ensures that the message arrives at a notification without any changes in levels. For example, one possible scheme is shown in the Table of FIG. 3d.

All references to commands herein may also refer to messages, and vice versa, except if specifically indicated otherwise.

An example of a packet broadcast is shown in FIG. 3e, wherein:
S=1-Start message (for synchronization to asynchronous system)
X=001-Setting the standby time (timer activation) until the operation is performed
D=Execute command (8 bits in the illustrated example, which allow up to 256 separate commands to be provided, of which only 6 are shown in FIG. 3c, for brevity)
C=error correction code e.g. based on CRC or Hamming code, or any other error correction conventional method

The result in the above example packet of FIG. 3e is as follows:
Command Received(1)
Time to execute the command-7 seconds(001)
Received command-Flashing LED at pace 1
Error checking-Standard (11) that both “1” and “O” are even

An example of transmission of similar commands with different timestamp and receiver operation mode is now provided, to illustrate how these commands may be received (or not) by the wearables' receivers.

What is broadcast is a blue LED activation command, merely by way of example. In the example, the number of broadcasts until the command is executed is 7. Thus, even if some wearable only corrected received on broadcast, and received 6 broadcasts incorrectly or not at all, that wearable can still participate.

In the illustrated example, the 7 broadcasts include:
First Command Broadcast-received is shown, by way of example, in FIG. 3f, wherein a blue LED activation command is received.

Start time: 7 seconds

Error Correction: Passed thus, this is a first occasion on which the command is received.

The system may set its internal timer for 7 seconds until the command is triggered.
Second Command Broadcast-did not reach destination
Third Command Broadcast got damaged; see example third command in FIG. 3g.

As shown in FIG. 3g, a blue LED activation command has been received.

Operating time: 5 seconds

However, Error Correction was not passed, so the system ignores the command
Fourth Command Broadcast-received; an example fourth command is shown in

FIG. 3h, wherein a blue LED activation command was received.

Operating time: 4 seconds

Error Correction: Passed. Thus, this is another occasion on which the same command is received.

The system may set its internal (typically software-implemented) timer for 4 seconds until the command is triggered.
Fifth Command Broadcast-received, e.g. as shown in FIG. 3j, wherein, again, what is shown is receipt of a blue LED activation command.

Run time: 3 seconds

Error Correction: Passed
Sixth Command Broadcast—not received
Seventh Command Broadcast-received e.g. as shown in FIG. 3k, wherein again what is shown is receipt of a blue LED activation command.

Time to Run: one second

Error Correction: passed

After one second, the command is executed and then, typically, the system returns to standby for a new command.

Any suitable components may be used in the apparatus of FIGS. 2a-2b. For example, use of the transmitter component of the LORA standard

100 mW transmission power may be transmitted, say, at 1 W transmission power,

And may for example use a broadcast module with FCC certificates.

Example: SX1276 433 MHz rf Module Transmitter Receiver 8000m E32-433T30D UART Long Range 433 MHz 1 W Wireless RF Transceiver. It is appreciated that all these parameters are indicated merely by way of example.

The unit's transmission method may be the LORA standard using, say, the spread spectrum method which allows the transmitter to reach larger ranges with the same energy consumption, with substantial improvement in overcoming obstacles.

The transmitter operation method may use a conventional broadcast transmission method. Any suitable broadcast error correction method may be employed, such as FEC (Forward Error Correction). Any suitable modem may be employed, e.g. if the LORA protocol is used. The LORA modem is described at the following link: http://m.il.ebyte-kr.net/lora-modem/915 mhz-lora-modem.html

A particular advantage of certain embodiments is that, despite its simplicity, the system is particularly convenient. The wearable (aka “sound package” or soundpack) is a useful device for a wide variety of venues, such as but not limited to live performances/sports events/parades/theaters/concerts/exhibitions, etc. that attendees may receive at any time prior to the start of the event, e.g. at the gate, or prior to the event, by courier to her or his home, and so forth. For example, the live show market is growing every year, and allows people to connect with their favorite artists. Or, the system is suited for events (e.g. weddings, parades) in which the participants move from place to place, yet it is desired to provide centrally controlled sound effects for them. Rather than moving a central sound system from place to place, to follow the participants, which is not always logistically simple, the participants carry the sound effects around with them, so to speak, and the event organizers need only ensure that the participants remain sufficiently close to (within range of, e.g.) the transmitter, or, vice versa, the event organizers may ensure that a transmitter is close enough to the participants.

According to certain embodiments, the “sound package” facilitates the ultimate upgrade of any live performance, providing an innovative and powerful experience through unique sound production and lighting for the audience, at 360 degrees. A sound package facilitates creation of a new performance experience that integrates the audience as part of the event. No longer need a performance take place just on stage. Instead, an entire event is provided which integrates the audience through sound, and the instrumental lighting is present wherever the audience or participants are present. Through use of the soundpack, everyone in the audience may become “speakers” which emit sounds that will enhance the audio experience on the show and allow the addition of a new musical instrument to the show—the audience. Sound and lighting files may be tailored to each performance set or performance, creating a new experience each time for the event and artist himself. In addition, different sound files can be completed, which transmit to different directions within the performance hall. After the show the participants may take the pack home with them, as a souvenir from the show

Special sound effects may be produced by playing a content-file e.g. sound file loaded into the plural devices before distribution thereof to end-users thereof, thereby to obviate any need for high-bandwidth transmissions during an ongoing event. Different sound files may be pre-loaded for each performance.

According to certain embodiments, portable devices may estimate their own distance from the transmitter, and e.g. relative to where the transmitter is located, typically at front of a music concert stage, may create time-aligned corrections to played sounds so as to ensure that sounds played by portable devices located close to the stage are heard at the same time as sounds played by devices located far from the stage, without delay. Thus the system may solve a sonic problem caused when electrical signals from transmitter reaches various devices, some further from the stage and some closer, simultaneously, although the sound traveling from the speakers near the stage travels through the atmosphere at the speed of sound, hundreds of times slower, potentially resulting in an undesirable gap several milliseconds long, between sources. Conventional time alignment techniques are referred to in the above-referenced sweetwater.com publication.

Many variations are possible such that the specific description herein is not intended to be limiting.

For example: distribution of devices adapted to different areas of the show complex can be carried out in any suitable manner, including but not limited to:
distribution of devices loaded with different information, according to the entrance gate;
distributing generic devices to all, and booting the system and files adapted by transferring the device in NFC or alternative short-range technology when entering through the relevant gateway to the appearance complex (e.g. used as power button-associates with location and triggers device activation).

The transmitter may or may not comprise an RF transmitter.

Different sound and/or lighting files may or may not be provided to audience members in different areas in the performance hall.

The course of action/s performed by the devices may include or produce any special effect, and are not limited to the particular special effects described herein by way of example.

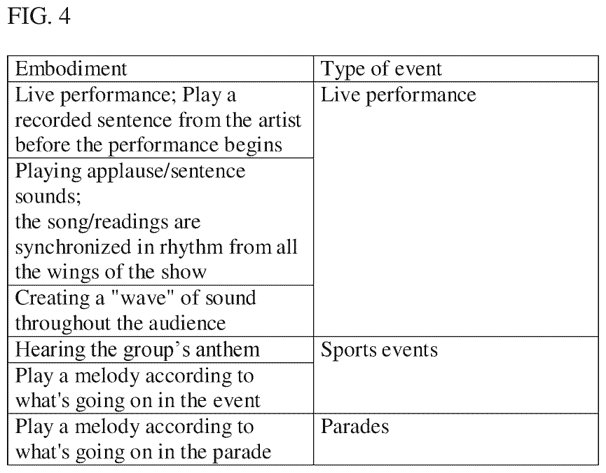

Also, many use cases are possible. The table of FIG. 4 illustrates embodiments which are particularly useful in various types of events. One example use case is generating a wave sound which travels around the crowd. In order to get the “wave” effect in the crowd that uses the wearable units, delay may be provided between the units, whose size depends on location. For example, event attendees located close to the stage (the “Golden Ring” area) may get the trigger earlier than those located further from the stage. To achieve a delay which yields a “wave” effect, each unit may be preprogramed with its delay time. The DJ may send the trigger to play the song/sound and each unit that may get the trigger to play the sound at a different time, thereby to achieve a “wave” effect. This is feasible if locations (e.g. each person's seat particulars) are known.

In sports events, the wearable units may, for example, play the team songs on each side of the stadium. For example, if the stadium is divided into two sections (say, yellow and red), and it is desired to play the team songs at a special moment e.g. when a team scores, a special song may be played only for the scoring side. To do this, the wearable units may be programmed in advance with suitable songs. The DJ may trigger the units by pressing a suitable command. For example, to play the red songs, the DJ may send command number 1 red and responsively, only the red units may play the song.

In parades, all wearable units may have the same sounds e.g. by preloading all wearables with the same sound files, and the DJ may trigger the sounds at suitable times. In parades, typically. In this process, all wearables play the same sounds.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices such as smartphones may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

A system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node.

It is appreciated that any features, properties, logic, modules, blocks, operations or functionalities described herein which are, for clarity, described in the context of separate embodiments, may also be provided in combination in a single embodiment except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

Each element e.g. operation described herein may have all characteristics and attributes described or illustrated herein or according to other embodiments, may have any subset of the characteristics or attributes described herein.

Devices, apparatus or systems shown coupled in any of the drawings, may in fact be integrated into a single platform in certain embodiments, or may be coupled via any appropriate wired or wireless coupling such as but not limited to optical fiber, Ethernet, Wireless LAN, Radio communication, HomePNA, power line communication, cell phone, VR application, Smart Phone (e.g. iPhone), Tablet, Laptop, PDA, Blackberry GPRS, satellite including GPS, or other mobile delivery.

It is appreciated that in the description and drawings shown and described herein, functionalities described or illustrated as systems and sub-units thereof, can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via Wifi, Bluetooth or Zigbee.

It is appreciated that implementation via a cellular app as described herein is but an example and instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include any apparatus, whether hardware, firmware or software, which is configured to perform, enable or facilitate that operation or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

1.-18. (canceled)

19. An audio effect production controlling method comprising:
providing a controller configured to provide instructions, on each of at least first and second occasions which are separated by a time interval whose length is t seconds, to a transmitter, to transmit commands to plural portable audio effect production devices, to produce an audio effect at a time separated by S seconds from the first occasion,
wherein, on the first occasion, the controller commands the plural portable audio effect production devices to begin producing the audio effect in S seconds,
and, on the second occasion, the controller commands the plural portable audio effect production devices to begin producing the audio effect in (S-t) seconds, thereby to control said plural devices, responsive to said controller, to produce the audio effect synchronously and to enable production of audio effects even by portable audio effect production devices which received only some of the commands transmitted on the at least first and second occasions
wherein said controller is activated to command the transmitter to transmit commands during an event, and wherein said portable devices each include memory and are each pre-loaded, before said event, with at least one sound file stored at at least one respective location in said memory, and wherein said audio effect comprises playing said at least one sound file responsive to said commands to the portable devices, thereby to reduce data streaming during the event,
wherein said plural devices include, at least:
a first subset of devices preloaded with a first sound file at a memory location 1 and
a second subset of devices preloaded with a second file at said memory location 1
and wherein said controller commands the devices to “play sound file at memory location 1”, thereby to generate an audio effect which includes, at least, the first subset of devices playing the first sound file and the second subset of devices playing the second file.

20. An audio effect production controlling system comprising:
a controller configured to provide instructions, on each of at least first and second occasions which are separated by a time interval whose length is t seconds, to a transmitter, to transmit commands to plural portable audio effect production devices to produce an audio effect at a time separated by s seconds from the first occasion,
wherein, on the first occasion, the controller commands the plural portable audio effect production devices to begin producing the audio effect in s seconds,
and on the second occasion, the controller commands the plural portable audio effect production devices to begin producing the audio effect in (s-t) seconds,
thereby to control said plural devices, responsive to said controller, to produce the audio effect synchronously, and to enable production of audio effects even by portable audio effect production devices which received only some of the commands transmitted on the at least first and second occasions
wherein said controller is activated to command the transmitter to transmit commands during an event, and wherein said portable devices each include memory and are each pre-loaded, before said event, with at least one sound file stored at at least one respective location in said memory, and wherein said audio effect comprises playing said at least one sound file responsive to said commands to the portable devices, thereby to reduce data streaming during the event
wherein said plural devices include, at least:
a first subset of devices preloaded with a first sound file at a memory location 1 and
a second subset of devices preloaded with a second file at said memory location 1
and wherein said controller commands the devices to “play sound file at memory location 1”, thereby to generate an audio effect which includes, at least, the first subset of devices playing the first sound file and the second subset of devices playing the second file.

21. A method according to claim 19 wherein at least one playback signal activation time is encoded so as to yield playback simultaneously for devices closer to the transmitter's location and for devices a further distance from said transmitter's location.

22. A computer program product, comprising a non-transitory tangible computer readable medium having computer readable program code embodied therein, the computer readable program code adapted to be executed to implement an audio effect production controlling method comprising:
providing a controller configured to provide instructions, on each of at least first and second occasions which are separated by a time interval whose length is t seconds, to a transmitter, to transmit commands to plural portable audio effect production devices, to produce an audio effect at a time separated by S seconds from the first occasion,
wherein, on the first occasion, the controller commands the plural portable audio effect production devices to begin producing the audio effect in S seconds,
and, on the second occasion, the controller commands the plural portable audio effect production devices to begin producing the audio effect in (S-t) seconds,
thereby to control said plural devices, responsive to said controller, to produce the audio effect synchronously and to enable production of audio effects even by portable audio effect production devices which received only some of the commands transmitted on the at least first and second occasions
wherein said controller is activated to command the transmitter to transmit commands during an event, and wherein said portable devices each include memory and are each pre-loaded, before said event, with at least one sound file stored at at least one respective location in said memory, and wherein said audio effect comprises playing said at least one sound file responsive to said commands to the portable devices, thereby to reduce data streaming during the event,
wherein said plural devices include, at least:
a first subset of devices preloaded with a first sound file at a memory location 1 and
a second subset of devices preloaded with a second file at said memory location 1
and wherein said controller commands the devices to “play sound file at memory location 1”, thereby to generate an audio effect which includes, at least, the first subset of devices playing the first sound file and the second subset of devices playing the second file.

23. The system according to claim 20 wherein said portable devices also produce at least one lighting effect.

24. The system according to claim 23 wherein said portable devices each include at least one light-emitting diode and wherein said lighting effect comprises activating said at least one light-emitting diode.

25. The system according to claim 20 and also comprising said transmitter which comprises an RF transmitter.

26. The system according to claim 20 wherein said second file comprises an empty file, thereby to generate an effect in which only the first subset of devices play the first sound file, whereas the second subset of devices is silent.

27. The system according to claim 20 wherein each portable device is configured to execute only a most recently received command, from among several commands received on several respective occasions.

28. The system according to claim 20 wherein said first and second subsets have first and second outward appearances respectively such that said first and second subsets of devices differ in their outward appearances.

29. The method according to claim 19 wherein devices loaded with first sound files are provided to audience members entering via a first gate and devices loaded with second sound files are provided to audience members entering via a second gate.

30. The system according to claim 20 wherein each of said portable devices is operative to estimate its own distance from the transmitter and/or to calculate delay, and wherein at least one of said commands comprises a command to said devices to “take a first course of action if your distance from the transmitter exceeds a threshold and a second course of action otherwise”, thereby to allow subsets of said portable devices which differ from one another in terms of their respective distances from the transmitter, to be simultaneously commanded to take different courses of action and/or to yield playback, simultaneously and without delay, for devices which are closer to the transmitter's location and for devices which are a further distance from said transmitter's location.

31. The system according to claim 30 wherein said portable devices estimate their own distances from the transmitter as a function of RSSI (Received Signal Strength Indicator) values characterizing commands said portable devices receive from the transmitter.

32. The system according to claim 30 wherein at least one of said courses of action comprises playing at least one given preloaded sound file.

33. The system according to claim 30 wherein at least one of said courses of action comprises taking no action.

34. The system according to claim 30 wherein said transmitter comprises at least 2 transmitters TXA and TXB deployed at locations a, b respectively, and wherein at least one individual portable device from among said portable devices is operative to estimate its own distances da and db from transmitters TXA and TXB respectively, to compare da and db and, accordingly, to determine whether said individual portable device is closer to location a or to location b.

35. The system according to claim 20 wherein said controller is operative to receive, from a human operator, a time TO at which the audio effect is desired and to command the transmitter to transmit said commands such that the time separated by S seconds from the first occasion is TO.

36. The system according to claim 20 wherein said commands to produce an audio effect include an indication of an intensity at which the audio effect is to be produced.
